(19) United States
(12) Patent Application Publication
(10) Pub. No.: US 2006/0274382 A1
(43) Pub. Date: Dec. 7, 2006

(54) Scanner

(75) Inventor: Liu-Zhi Yang, Suzhou (CN)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/444,874

(22) Filed: Jun. 1, 2006

(30) Foreign Application Priority Data
Jun. 2, 2005 (TW) TW94118163

(51) Int. Cl. H04N 1/04

(52) U.S. Cl. 358/474

(57) ABSTRACT

A scanner. The scanner comprises a main body having a scanning area, a cover rotatably connected to the main body, a baffle detachably disposed between the main body and the cover and comprising a flange abutting the edge of the scanning area to hold a document, and at least one connector connecting the flange and the main body. When the cover is opened, the document is placed on the baffle and maintained thereon. When the cover is closed, the document is clamped between the main body and the baffle.

### BACKGROUND

The invention relates to a scanner, and in particular to a vertical scanner holding scanned documents without oblique or slipping conditions.

In general, scanners are laid on a table for use. As the space available for a computer, display, scanner and printer is limited, and the scanner may occupy a considerable space, a vertical scanner has been introduced.

In vertical scanners, however, document positioning is problematic. TAIWAN R.O.C patent No. 529869 discloses a vertical scanner to solve the positioning problem. Referring to FIGS. 1A to 1C, a conventional vertical scanner comprises a housing 1, a glass plate 2, a cover 3 and a seat 4. The cover 3 is rotatably connected to the housing 1 via a pivot 7. The housing 1 is vertically positioned on the seat 4. A flange 11 extends from the housing 1 adjacent to the junction of the housing 1 and the glass plate 2. A document 5 is positioned on the cover 3 with one edge thereof abutting the flange 11. In FIG. 1B, each end of the flange 11 has an upward protrusion 12 to constrain the document 5 in the right and left direction. In addition, a guide and press mechanism 6 is disposed on the inner surface of the cover 3 and has a curved surface. The curved surface protrudes toward the glass plate 2 and has a central portion with a maximum height, whereby the document 5 is pressed against the glass plate 2.

As the flange 11 and the protrusion 12 are integrally formed on the housing, the size must be as small as possible to allow the cover 3 to cover the glass plate 2 completely. Accordingly, the document 5 must be placed on the small flange 11 for positioning such that the document 5 may easily slip and fall off the glass plate 2. The positioning is difficult, and causes inconvenience in operation and poor scan quality. In addition, the guide and press mechanism 6 has certain Height and affects clearance between housing 1 and cover 3. Due to the flange, the cover 3 cannot completely cover the housing 1.

### SUMMARY

An embodiment of a scanner of the invention comprises a main body with a scanning area, a cover rotatably connected to the main body, a baffle detachably disposed between the main body and the cover and comprising a flange abutting the edge of the scanning area to hold a document, and at least one connector connecting the flange and the main body. When the cover is opened, the document is placed on the baffle and maintained thereon. When the cover is closed, the document is clamped between the main body and the baffle.

The flange comprises a depression, and the main body comprises at least one first groove. One end of the connector slidably joins the depression and another end of the connector is inserted into the first groove.

The connector can comprise a hook on one end thereof corresponding to and latching the depression. The flange can comprise at least one slot corresponding to the depression, through which the connector passes to latch the depression.

The cover can comprise an accommodating portion accommodating the connector.

The scanner of the invention further comprises a soft pad attached to the baffle. When the cover is closed, the soft pad contacts the document.

The scanner of the invention further comprises a bracket rotatably connected the main body to support the main body.

Another embodiment of a scanner of the invention comprises a main body comprising a scanning area and two second grooves formed on two sides thereof, a cover rotatably connected to the main body, and a baffle detachably disposed between the main body and the cover comprising a flange with two ends thereof inserted into the second grooves to hold a document. When the cover is opened, the document is placed on the baffle and maintained thereon. When the cover is closed, the document is clamped between the main body and the baffle. The second grooves can be C-shaped or O-shaped.

### BRIEF DESCRIPTION OF THE DRAWINGS

The invention can be more fully understood by reading the subsequent detailed description and examples with references made to the accompanying drawings, wherein:

FIG. 1A is a schematic view of a conventional vertical scanner;

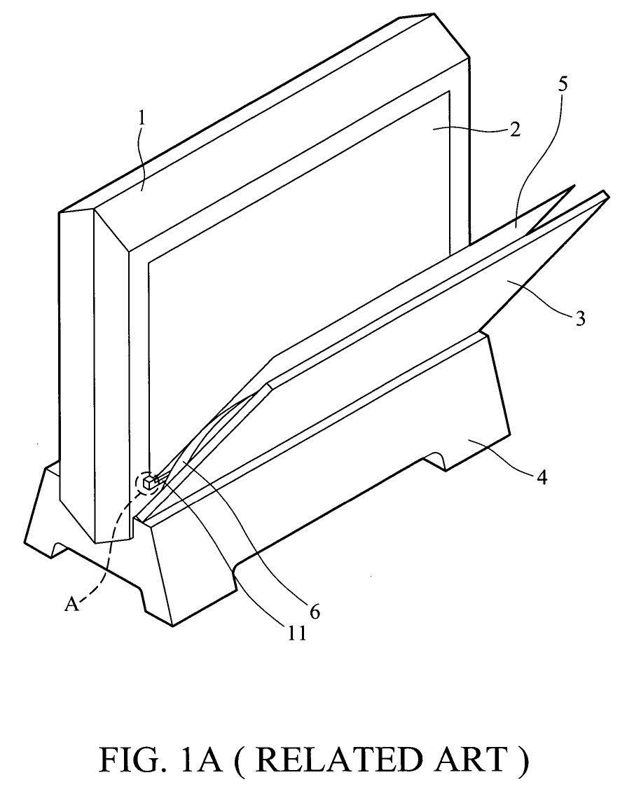

FIG. 1B is partially enlarged view of region A of FIG. 1A;

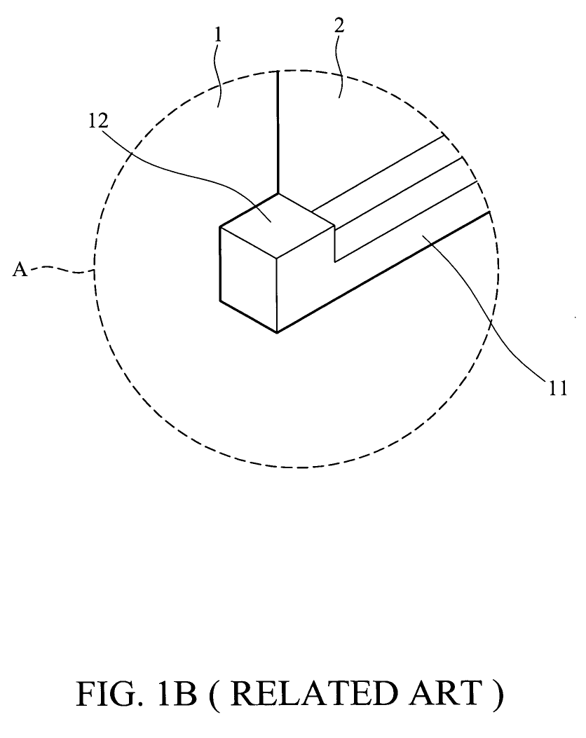

FIG. 1C is a side view of the conventional vertical scanner of FIG. 1

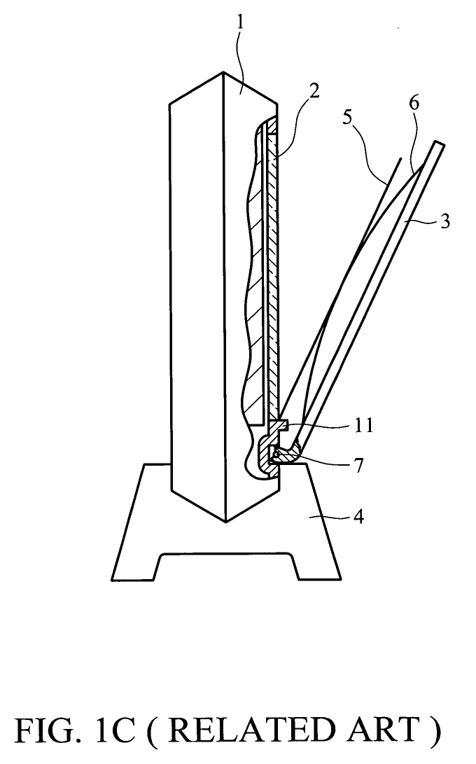

FIG. 2A is an exploded view of an embodiment of a vertical scanner of the invention;

FIG. 2B is an exploded view of the baffle and the connector of FIG. 2A;

FIG. 2C is a partially enlarged view of the baffle observed in the direction X of FIG. 2B;

FIG. 2D is a schematic view showing the connector joining the baffle;

FIG. 2E is a schematic view of the connector connecting the main body and the baffle observed in the direction A of FIG. 2A;

FIG. 2F is a schematic view of the connector accommodated in the cover;

FIG. 2G is a schematic view of the connector removed from the cover;

FIG. 3A is a schematic view of another embodiment of a scanner of the invention;

FIG. 3B is a partially enlarged view of the baffle of FIG. 3A;

FIG. 3C is a partially enlarged view of the baffle and the main body observed in the direction B of FIG. 3A; and

FIG. 3D is a partially enlarged view of the groove of the main body of FIG. 3C.

### DETAILED DESCRIPTION

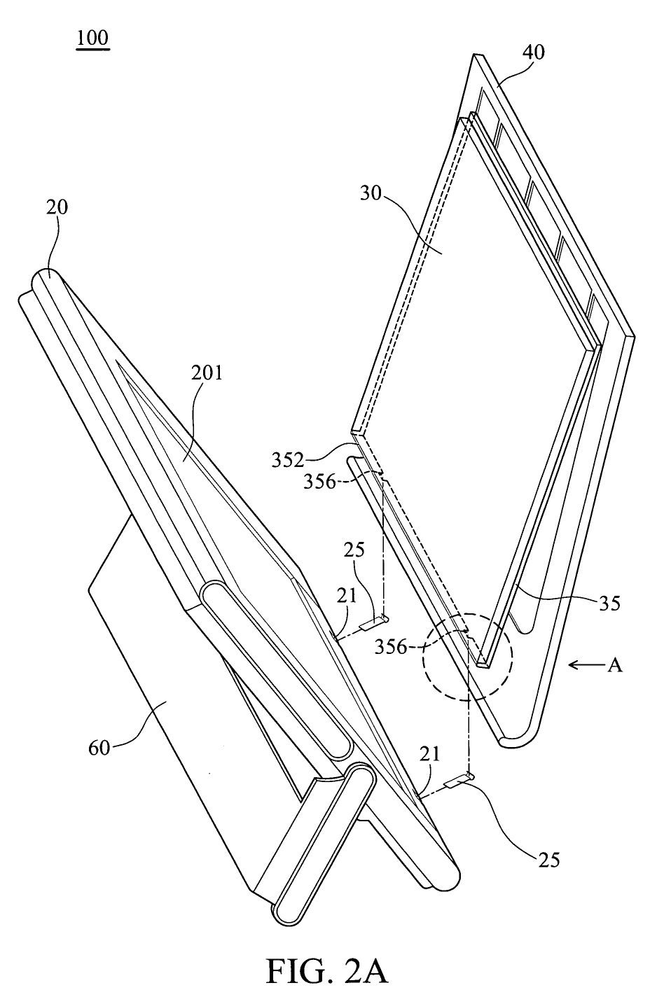

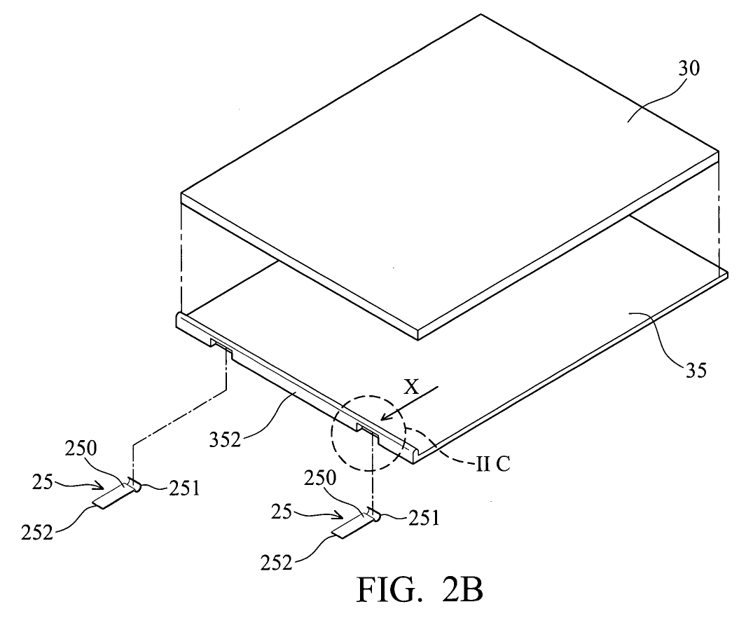

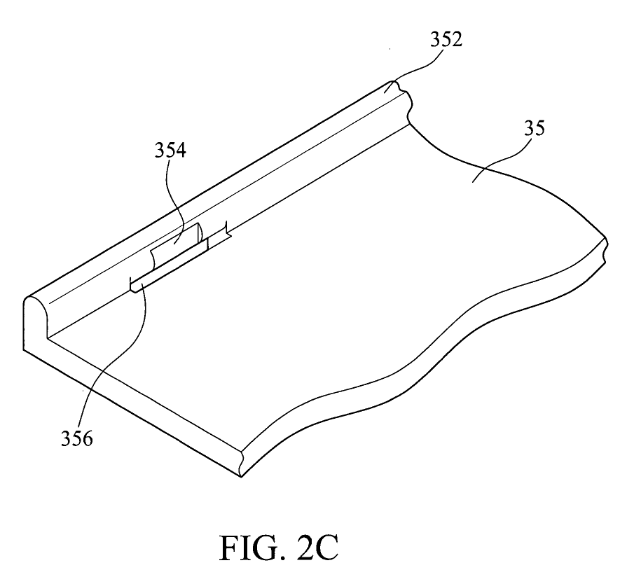

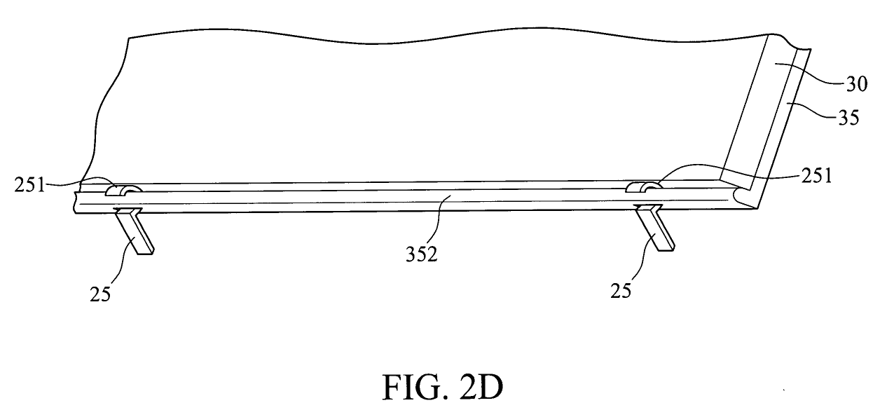

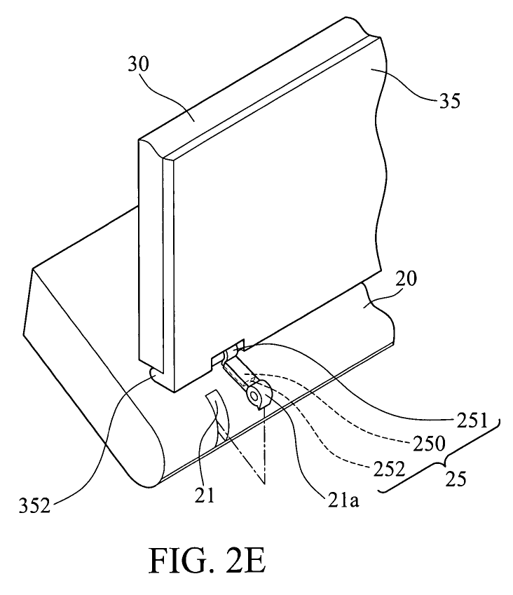

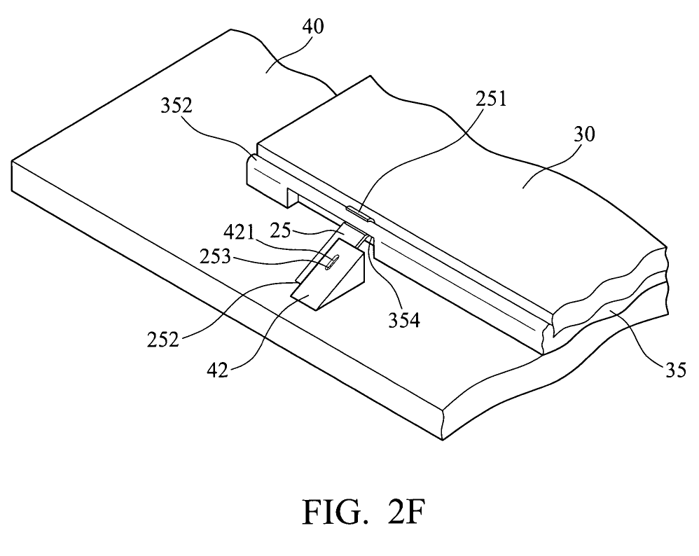

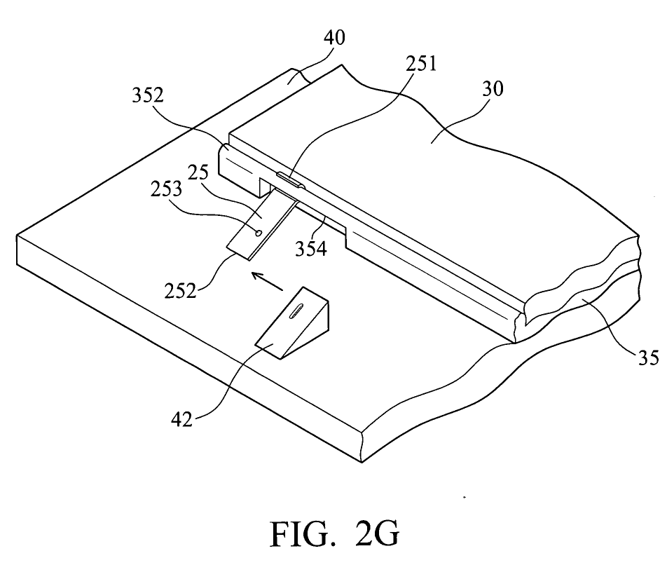

Referring to FIG. 2A, a scanner 100 is positioned vertically for scanning documents, pictures or films and the like. The scanner 100 comprises a main body 20, a cover 40, a baffle 35, a soft pad 30, a connector 25 and a bracket 60. The cover 40 is rotatably connected to the main body 20. The soft pad, which can be made of sponge or other soft material, is attached to the baffle 35. The baffle 35 is detachably disposed between the main body 20 and the cover 40 and comprises a flange 352 abutting one edge of scanning area 201 of the main body 20 to hold a scanning document. The flange 352 has a round front. The connector 25 connects the flange 352 and the main body 20. In this embodiment, the scanner 100 is vertically positioned, and the bracket 60 is rotatably connected to the main body 20 and supports the main body 20. When the scanner 100 is hung on a wall, the bracket 60 can be eliminated. When the cover 40 is opened and the document is placed on the baffle 35, as the flange 352 abuts the main body 20, the document leans on the baffle 35. When the cover 40 is closed, the soft pad 30 contacts the document, whereby the document is clamped between the main body and the baffle 35.

The scanner 100 comprises at least one connector 25 comprising a link 250 and two ends 251 and 252. The connector 25 can be a metal pin. In detail, the end 251 is a C-shaped hook. The flange 352 comprises at least one depression 354 as shown in FIG. 2C. The depression 354 corresponds to the end 251. The flange 352 further comprises a gap 356 corresponding to the depression 354. The connector 25 passes through the gap 356 to join the depression 354 as shown in FIG. 2D.

Referring to FIG. 2E, the main body 20 comprises at least one first groove 21 in which a shaft 21a is disposed, and the first groove 21 corresponds to the other end 252 which is inserted into a first groove 21. Accordingly, the end 252 joins the shaft 21a and is disposed in the first groove 21. The joining mechanism between the shaft 21a and the end 252 is not limited. In this embodiment, the end 251 of the connector 25 slidably joins the depression 354.

In addition, the cover 40 comprises a accommodating portion 42 accommodating connector 25 as shown in FIGS. 2F and 2G. In this embodiment, the connector 25 comprises a protrusion 253, and the accommodating portion 42 comprises a hole 421 in which the protrusion 253 is inserted, enabling the accommodating portion 42 to accommodate the connector 25. When not in use, the end 252 is detached from the shaft 21a, and the connector 25 is accommodated in the accommodating portion 42, whereby the baffle 30 is received in the cover 40. In FIG. 2G, the end 251 can slide rightward or leftward in the depression 354 enabling the other end 252 to enter or release from the accommodating portion 42.

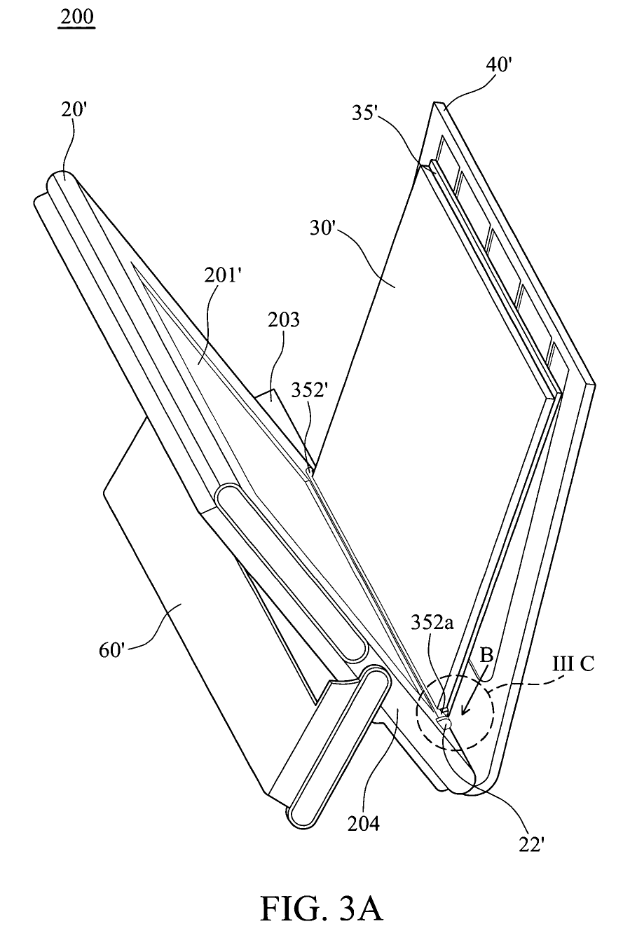

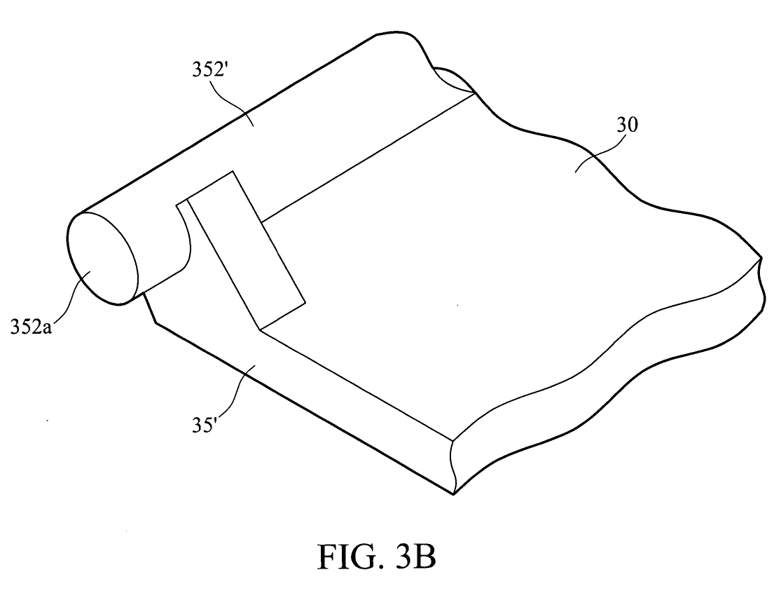

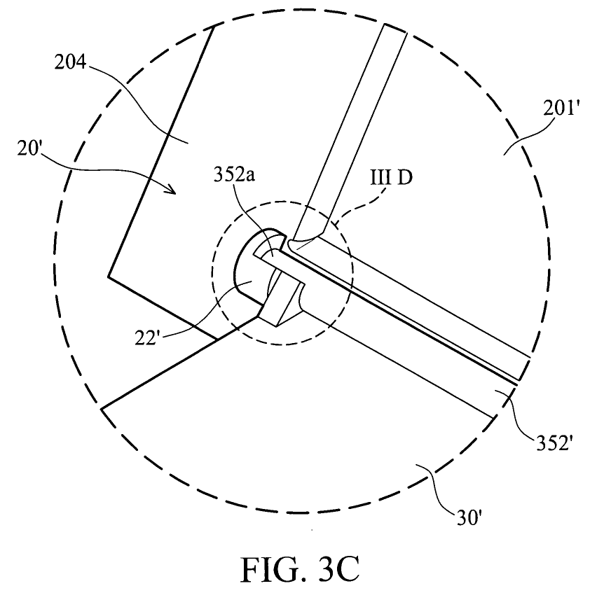

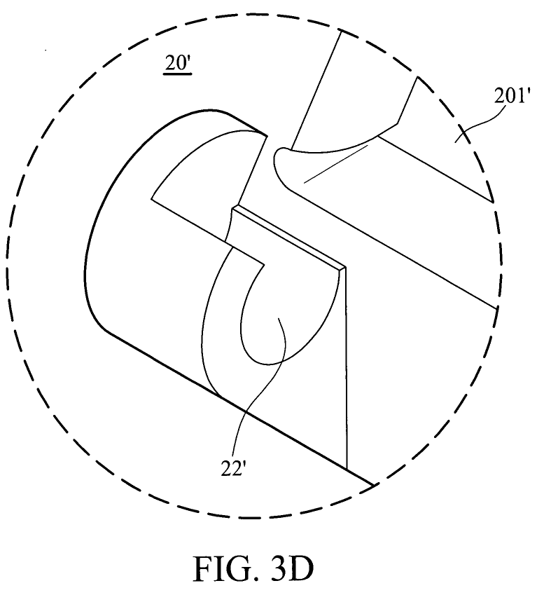

FIGS. 3A, 3B, 3C and 3D depict another embodiment of the invention. In FIG. 3C, the soft pad 30′ is omitted for the sake of clearly showing the connection of the baffle 35′ and the main body 20′.

The description of the same elements of this embodiment with the previous embodiment is omitted. In this embodiment, the connector 25 and the first groove 21 are neglected. The main body 20′ comprises two second grooves 22′ formed on two sides thereof, which corresponds to two ends 352a of the flange 352′. Each end 352a engages one second groove 22′ as shown in FIG. 3A. In FIGS. 3C and 3D, the second grooves 22′ are C-shaped, whereby the baffle is stably connected to the main body 20′. The second grooves 22′ can also be O-shaped.

In this embodiment, the baffle 25′ is made of soft material. When the scanner is not used, the baffle 25′ can be detached from the main body 20′.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a main body having a scanning area;
a cover rotatably connected to the main body;
a baffle detachably disposed between the main body and the cover, comprising a flange abutting the edge of the scanning area to hold a document; and
at least one connector connecting the flange and the main body, wherein when the cover is opened, the document is placed on the baffle and maintained thereon, and when the cover is closed, the document is clamped between the main body and the baffle.

2. The scanner as claimed in claim 1, wherein the flange comprises at least one depression, and the main body comprises at least one first groove, wherein one end of the connector slidably joins the depression and another end of the connector is inserted into the first groove.

3. The scanner as claimed in claim 2, wherein the connector comprises a hook on the one end thereof corresponding to and latching the depression.

4. The scanner as claimed in claim 2, wherein the flange comprises at least one slot corresponding to the depression, through which the connector passes to latch the depression.

5. The scanner as claimed in claim 2, wherein the connector is metal.

6. The scanner as claimed in claim 2, wherein the one end of the connector is C-shaped.

7. The scanner as claimed in claim 2, wherein the connector is a pin.

8. The scanner as claimed in claim 1, wherein the cover comprises an accommodating portion accommodating the connector.

9. The scanner as claimed in claim 1, wherein the flange has a round front.

10. The scanner as claimed in claim 1 further comprising a soft pad attached to the baffle, wherein when the cover is closed, the soft pad contacts the document.

11. The scanner as claimed in claim 1, wherein the scanner is used vertically.

12. The scanner as claimed in claim 1 further comprising a bracket rotatably connected the main body to support the main body.

13. A scanner, comprising:
a main body comprising a scanning area and two second grooves formed on two sides of the main body;
a cover rotatably connected to the main body; and
a baffle detachably disposed between the main body and the cover, comprising a flange with two ends thereof inserted into the second grooves to hold a document, wherein when the cover is opened, the document is placed on the baffle and maintained thereon, and when the cover is closed, the document is clamped between the main body and the baffle.

14. The scanner as claimed in claim 13, wherein the second grooves are C-shaped or O-shaped.

15. The scanner as claimed in claim 13 further comprising a soft pad attached to the baffle, wherein when the cover is closed, the soft pad contacts the document.

16. The scanner as claimed in claim 13, wherein the scanner is used vertically.

17. The scanner as claimed in claim 1 further comprising a bracket rotatably connected the main body to support the main body.
